(19) United States
(12) Patent Application Publication
(10) Pub. No.: US 2008/0252588 A1
(43) Pub. Date: Oct. 16, 2008

(54) Column Electrode Driving Circuit and Display Device Using It

(75) Inventor: Zhong Shou Huang, San Jose, CA (US)

Correspondence Address: LIU & LIU, 444 S. FLOWER STREET, SUITE 1750, LOS ANGELES, CA, 90071, US

(73) Assignee: TPO HONG KONG HOLDING LIMITED

(21) Appl. No.: 11/884,586

(22) PCT Filed: Feb. 24, 2006
(86) PCT No.: PCT/IB2006/050589

§ 371 Date: Aug. 16, 2007

(30) Foreign Application Priority Data
Feb. 25, 2005 (JP) 2005-051352

(51) Int. Cl. G09G 3/36

(52) U.S. Cl. 345/100

(57) ABSTRACT

An object of the invention is to mitigate effect of variations of electrical characteristics or other performances of amplifiers used in a driving circuit system and combat the so-called artifact such as stripe patterns in displayed images even in a case of the same gray-scale of display. A column electrode driving circuit 33 of the invention comprises: signal supply means (7, 8, 9, 10, 20) for outputting a plurality of multiplexed information signals in which column information signals to be applied to at least two column electrodes S1, S2, . . . respectively are time-divisionally multiplexed; selecting means 30 having outputs of the same number as the multiplexed information signals for selecting any one of the outputs for each of the multiplexed information signals and outputting a multiplexed information signal from the selected output; and demultiplex means 40 for demultiplexing the multiplexed information signals outputted from the selecting means 30, respectively, and producing a column information signal to be applied to the corresponding column electrode. The selecting means 30 switches or sets a selecting state of the outputs for the multiplexed information signals at predetermined intervals.

### TECHNICAL FIELD

The present invention broadly relates to a column electrode driving circuit. Particularly, the present invention relates to a column electrode driving circuit for driving plural column electrodes arranged so as to respectively intersect with plural row electrodes. Also, the present invention relates to a display device using such a driving circuit.

### BACKGROUND ART

There are conventional liquid crystal display devices intended to generate plural multiplexed information signals obtained by time-division multiplexing the column information signals respectively corresponding to pixel information to be supplied to plural column electrodes, to output these multiplexed information signals through their respective buffer amplifiers, to receive the multiplexed information signals from the buffer amplifiers and respectively demultiplex them, and to produce column information signals to be supplied to the corresponding column electrodes, whereby the column information signals are supplied to the column electrodes. By such a configuration, the buffer amplifiers take charge of driving of the plural column electrodes, so that the total number of buffer amplifiers required can be decreased.

This type of liquid crystal display device is disclosed in Patent Document 1.

[Patent Document 1] Japanese Patent Application Laid-Open No. 10997/98 (particularly, see FIG. 5 and paragraph numbers [0024] to [0028])

### DISCLOSURE OF INVENTION

### Technical Problem

However, in the liquid crystal display device as described in Patent Document 1, a demultiplexer (Mux) for demultiplexing the multiplexed information signals receives outputs from the amplifiers (buffer amplifiers) assigned to the demultiplexers, respectively, so that quality (particularly, amplitude) of column information signals (pixel driving signals) obtained as outputs of the demultiplexer depends strongly on performances of the amplifiers including electrical characteristics and more. Therefore, variations in the performances of the amplifiers cause the column information signals to vary on a demultiplexer basis because the demultiplexers are the output sources of the column information signals. In addition, not only those of the amplifiers, but also signal propagation characteristics of the demultiplexers themselves are not strictly equal to each other, and so variations on a demultiplexer basis would be brought to the column information signals.

The column information signals influenced by such variations are supplied to the column electrodes as they are unless correction is made for eliminating the variations, resulting in variations in driving of pixel driving transistors, pixel electrodes or pixel-corresponding liquid crystal cells indirectly. Therefore, pixel information displayed varies every demultiplexer. Assuming that a multiplexed information signal carries e.g. three column information signals to be supplied to three column electrodes, even in the case of attempting to drive pixels of all the columns in a display area in the same gray-scale level, a visible difference in level of gray-scale would occur between pixels associated with three column electrodes handled by one demultiplexer and pixels associated with three column electrodes handled by the next demultiplexer. This difference appears as a stripe pattern of pixels along the column electrodes in the case of attempting to display the same color on a whole display screen, but even for normal image display situation in which color is not the same and various colors exist with mixture, the image display is similarly influenced by the difference, thereby resulting in an obstacle to improving image quality.

### Technical Solution

The present invention has been implemented in view of such problems, and its object is to provide a column electrode driving circuit and a display device, which can achieve high image quality display.

Another object of the present invention is to provide a column electrode driving circuit and a display device, which can reduce an influence of variations in performance including electrical characteristics and more of amplifiers used in a driving circuit system and thereby resist the so-called artifact such as a stripe pattern in a displayed image even for displaying at the same gray-scale level.

In order to achieve the objects mentioned above, a first aspect of the present invention is a driving circuit for driving a plurality of column electrodes arranged in such a manner that the column electrodes cross a plurality of row electrodes, respectively, comprising: signal supply means for outputting a plurality of multiplexed information signals in which column information signals to be applied to at least two column electrodes respectively are time-divisionally multiplexed; selecting means having outputs of the same number as the multiplexed information signals for selecting any one of the outputs for each of the multiplexed information signals and outputting a multiplexed information signal from the selected output; and demultiplex means for demultiplexing the multiplexed information signals outputted from the selecting means, respectively, and producing a column information signal to be applied to the corresponding column electrode, the selecting means switching or setting a selecting state of the outputs for the multiplexed information signals at predetermined intervals (claim 1).

By doing so, the demultiplexing means are provided with the multiplexed information signals through different signal paths changed at the predetermined time intervals, so that deviations in electrical characteristics between the signal paths can be scattered between one selection state and another selection state. Therefore, variations in performances including electrical characteristics and more of amplifiers (claim 2) etc. used in signal supply means are visually reduced, so that the so-called artifact such as stripe pattern in displayed images can become inconspicuous even in the same gray-scale level displaying.

In this aspect, the signal supply means may comprise second selecting means having outputs of the same number as the multiplexed information signals for selecting any one of the outputs for each of the multiplexed information signals and outputting a multiplexed information signal from the selected output, the second selecting means being selection-controlled in conjunction with the selecting state to keep a series of multiplexed information signals to be inputted to the demultiplex means, to be the same, even if the selecting state is changed (claim 3). Thus, the sequence of the signals inputted to the demultiplexing means can be maintained constant by disposing another selection means in the upstream side.

Also, the column information signal may be a pixel information signal, and the predetermined interval may be a horizontal scanning period, frame or field period for a video signal formed by a group of the pixel information signals, or a multiple thereof (claim 4). This is advantageous in that the predetermined time interval can be set relatively simply. Such a predetermined time interval does not need to be limited to be constant, and may also be varied regularly or irregularly to the extent permitted by other conditions.

Also, flicker of the stripe pattern can be prevented by randomly setting the selection state (claim 5).

Further, the row electrodes may be selected according to a predetermined sequence or at a defined pattern, and the multiplexed information signals may be updated each time selection-switching for the row electrodes are performed (claim 6). The herein-said prescribed pattern has the meaning of covering a situation in which a plurality of row electrodes may simultaneously be selected depending on configuration and control of a display panel applied thereto.

The present invention is also directed to a further aspect constructed by using the above-mentioned aspect and its subordinate concepts, and provides a display device in which pixels are matrix-addressed by signals supplied to the row and column electrodes (claim 7).

In this aspect, there may be provided a display device having a display panel in which the signal supply means, the selecting means and the demultiplex means are formed (claim 8), or a display device having a display panel in which the selecting means and the demultiplex means are formed and an electronic board provided as a peripheral appendix member for the display panel, in which the signal supply means are formed (claim 9). There are advantages peculiar to each. Then, there may be provided a display device having active elements or other drive elements for controlling a driving state for each pixel in accordance with signals supplied to the row and column electrodes, the selecting means and demultiplex means being formed in a common process to a layer or material forming the drive elements (claim 10), and further a display device in which the display panel is a liquid crystal display panel, and the drive elements are thin film transistors formed in a low temperature polysilicon technology (claim 11).

### BRIEF DESCRIPTION OF DRAWINGS

FIG. 1 is a block diagram showing a basic general configuration of a liquid crystal display device according to one embodiment of the present invention.

FIG. 2 is a block diagram showing an internal configuration of a source driver shown in FIG. 1.

FIG. 3 is a time chart representing an action of the configuration of FIG. 1.

FIG. 4 is a block diagram showing an alternative of the configuration shown in FIG. 2.

FIG. 5 is a block diagram showing an equivalent circuit of the configuration shown in FIG. 4.

### BEST MODE FOR CARRYING OUT THE INVENTION

The above-mentioned aspects and other modes of the present invention will be described below in detail by way of embodiments with reference to the accompanying drawings.

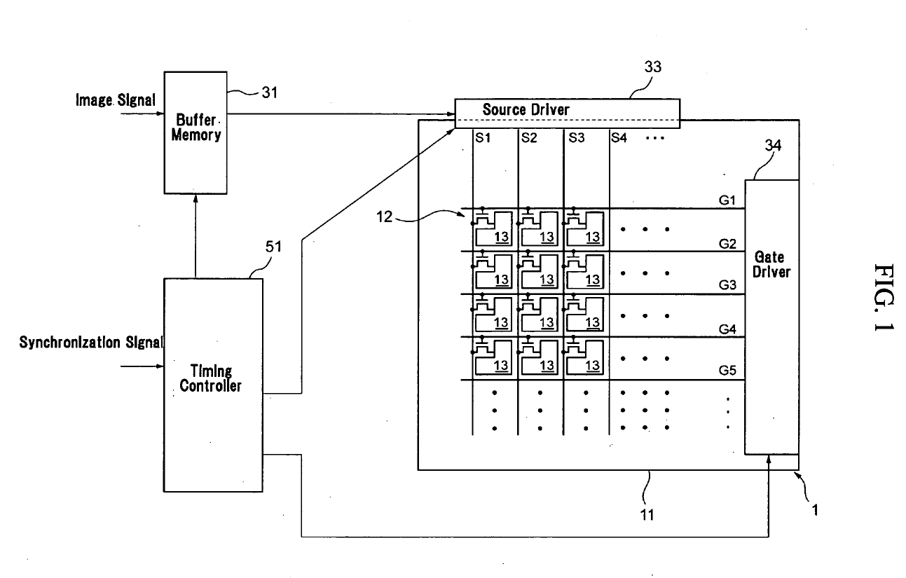

FIG. 1 shows a basic general configuration of a liquid crystal display device according to one embodiment of the present invention.

In the figure, this liquid crystal display device is mainly comprised of a liquid crystal display panel 1 of, e.g. a transmission type, and peripheral circuitry for generating signals and voltages necessary to control or drive the panel 1 and supplying the signals and voltages.

The liquid crystal display panel 1 makes a liquid crystal layer (not shown) sandwiched by two opposed transparent substrates take charge of optical modulation according to an image to be displayed. In the present example, the liquid crystal display panel 1 adopts an active matrix type configuration, and in one substrate 11 of the back side of the panel, thin film transistors (TFTs) 12 of a field effect type as active elements for pixel driving are arranged in matrix in correspondence with the pixels within a predetermined display area. Gate electrodes of these TFTs 12 are respectively connected to plural row electrodes Gx (x=0, 1, 2, . . . ; hereinafter, called “gate lines” when necessary) constituting the so-called scanning lines extending in parallel mutually in a lateral (horizontal) direction in the display area, and source electrodes of the TFTs are respectively connected to plural column electrodes Sy (y=0, 1, 2, . . . ; hereinafter, called “source lines” when necessary) constituting the so-called signal lines extending in parallel mutually in a longitudinal (vertical) direction in the same display area. Drain electrodes of the TFTs 12 are individually connected to pixel electrodes 13.

The other substrate of the display panel 1, which is a front side substrate (not shown) disposed oppositely to the back substrate 11 with a gap, is provided with a common electrode (not shown) formed over a principal surface (inside surface of the panel) opposed to the pixel electrodes 13. A liquid crystal medium not shown is sealed in a gap between the back substrate 11 and the front substrate to form the liquid crystal layer.

While the TFTs 12 are selectively turned on for each row by a gate signal acting as a row selection signal supplied through the gate line Gx, the TFTs 12 are controlled in any driving state according to pixel information to be displayed by levels of source signals acting as column information signals (or pixel information signals) supplied through the source lines Sy to the respective TFTs 12 having turned on. Potential according to such a driving state is given to the pixel electrode 13 via the associated drain electrode. The orientation in the liquid crystal medium is controlled for each pixel electrode by an electric field of strength determined by a difference between this pixel electrode potential and a level of a voltage supplied to the common electrode. Thus, the liquid crystal medium can modulate the back illumination light from a backlight unit and control the amount of transmission of the backlight to the front side, in accordance with the pixel information for each pixel. Details about a basic configuration of such a liquid crystal display panel are well known in various documents, so that further description is no longer made herein.

In FIG. 1, the peripheral circuitry shown as components other than the display panel 1 (component parts in the display area) can be broadly classified into a display panel driving system 3 and a system control system 5.

The display panel driving system 3 has a buffer memory 31 acting as image signal processing means, a source driver 33 acting as a column electrode driving circuit, a gate driver 34 acting as a row electrode driving circuit, and a voltage generation circuit, not shown, acting as common electrode driving means.

In the buffer memory 31, digital image signals of the red (R), green (G) and blue (B) for one frame each are serially received from an image signal supply system, not shown, and these image signals are temporarily stored or written frame-sequentially, while the stored image signals are read out for each scanning line based on a control signal from a timing controller 51 to transfer them to the source driver 33. Based on a control signal from the timing controller 51, the transferred image signals are held in the source driver 33 and subjected to digital-to-analog conversion etc. The source driver 33 respectively supplies the held image signals for one scanning line to the source lines Sy as source signals (column information signals or pixel information signals) corresponding to the pixels. More detailed function and configuration of the source driver 33 will be described below.

The gate driver 34 performs control of selecting any of the scanning lines, that is, the gate lines Gx based on a control signal from the timing controller 51. Such selecting of the gate lines is made by generating a gate signal for applying a predetermined, for example high level voltage to the gate line to be selected.

A voltage generation circuit, not shown, supplies an appropriate voltage signal to a common electrode based on a control signal from the timing controller 51. This voltage signal may be of direct current, but it may be of alternating current in conformance with the so-called AC driving method. A level of this voltage signal becomes a reference potential of a source signal supplied to the source line Sy.

In the present example, the timing controller 51 in which processing steps can be previously programmed is adopted as the system control system 5. The timing controller 51 receives a synchronization signal of an image signal from an image signal supply system (not shown), and generates various control signals for taking charge of timing and operational instructions necessary for the components described above on the basis of this synchronization signal. The synchronization signal received herein may include a dot clock signal indicating data transfer timing for each pixel, the so-called horizontal and vertical synchronization signals, and a frame synchronization signal indicating a frame period, etc. The timing controller 51 generates control signals for managing control necessary for the display panel 1 based on these synchronization signals.

In this embodiment, a part of the source driver 33 and the gate driver 34 are formed in the display panel 1 (the back substrate 11 in the this example). Also, the panel 1 is manufactured in an LTPS (low temperature polysilicon) technique and the TFTs 12 are manufactured using materials and processes compliant with this technique. By such an LTPS technique, a pixel driving portion formed in the display area, including the TFTs 12, the gate and source lines connected to these TFTs and the like, and (at least a part of) a peripheral circuit portion for supplying a necessary signal to the pixel driving portion are formed in the same substrate.

Next, a more concrete configuration of the source driver 33 will be described.

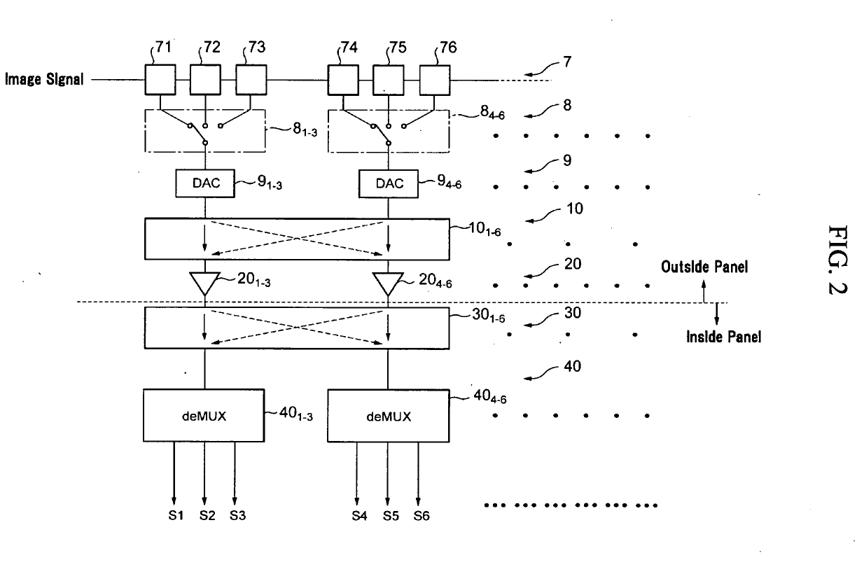

FIG. 2 shows an internal configuration of the source driver 33, and it comprises at the first stage a shift register consisting of unit registers (or latch circuits) 71, 72, 73, . . . for serially receiving digital image signals (hereinafter, called image data) from the buffer memory 31 and holding these data for one scanning line. The unit registers hold the image data for each pixel or column electrode, that is, for each source line. The first unit register 71, the second unit register 72 and the third unit register 73 hold the image data used as the origin of source signals to be supplied to the first source line S1, the second source line S2 and the third source line S3, respectively. The subsequent unit registers including the fourth unit register 74 similarly hold the image data (hereinafter, called source signals or column information signals) that are the origins of source signals to be supplied to the corresponding source lines, respectively. A set of column information signals corresponds to information signals of pixels related to one scanning line, and a set obtained by collecting a plurality of pixel information signals each serving one line corresponds to image signals for one frame or field.

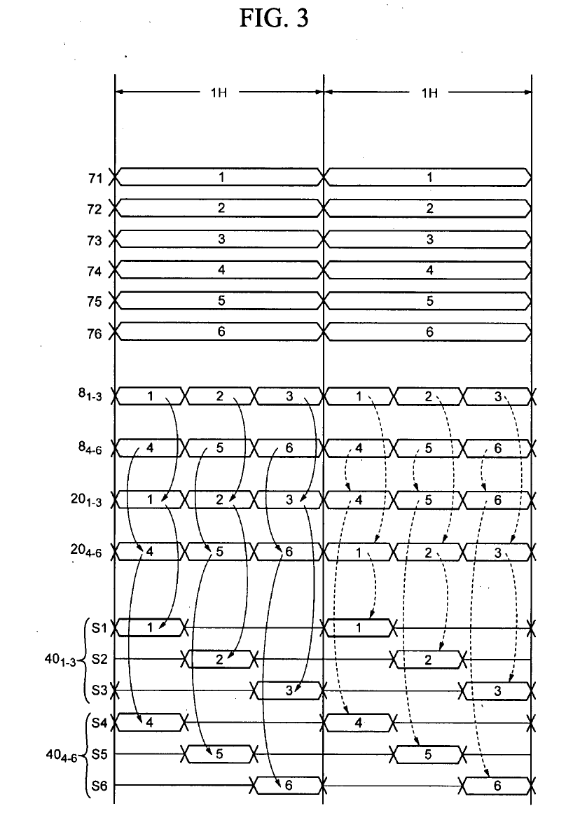

FIG. 3 typifies the unit registers 71 to 76 and schematically shows holding states of these registers. Incidentally, reference numerals of components necessary for description among the components shown in FIG. 2 are represented in the left side of FIG. 3, and output states of the components are represented by schematic waveforms of the corresponding right side. Also, numbers shown inside the schematic waveforms refer to numbers of the source lines to which the source signals carried by the outputs will be supplied (the following is in a similar way to the above).

Each of the holding outputs of the shift register is subjected to processing of time-division multiplexing in multiplexers 8₁₋₃, 8₄₋₆, . . . disposed at the next stage. These multiplexers adopt a configuration to perform processing of source signals to be supplied to respectively corresponding three source lines; the multiplexer 8₁₋₃, for example, is arranged to allocate the holding outputs of the first to third unit registers 71 to 73 to 3-equally divisional periods within a horizontal scanning period (H), respectively and to output them (see FIG. 3). Such a configuration can be formed by a switching element for selectively making electrical continuity between any one of three inputs and a single output. Other multiplexers including the multiplexer 8₄₋₆ also multiplex the corresponding register holding outputs in the similar way. Thus, the multiplexers output the multiplexed source signals (multiplexed information signals). As shown in FIG. 3, the multiplexed source signals adopt a form in which the source signals are respectively distributed to three divisional equal periods within 1 H.

The outputs of the multiplexers are supplied to DACs (digital-to-analog converters) 9₁₋₃, 9₄₋₆, . . . , wherein analog multiplexed source signals having analog levels corresponding to digital values of the input multiplexed source signals are obtained.

The outputs of the DACs are supplied to first selection circuits 10₁₋₆, 10₇₋₁₂, . . . . The first selection circuit has a configuration of receiving two DAC outputs in this example. The first selection circuit is arranged to have the output terminals of the same number (two in the present example) as the number of inputs and select any one of the output terminals for each input and relay input signals to the selected output terminals. Therefore, in one selection state, one input and the other input are respectively directed to the corresponding one output and the other output (see arrows of solid lines shown in the selection circuit 10₁₋₆ in FIG. 2), and in another selection state, the one input is directed to the other output and the other input is directed to the one output (see arrows of dotted lines shown in the selection circuit 10₁₋₆ in FIG. 2).

The multiplexed source signals outputted from the first selection circuits are outputted through buffer amplifiers 20₁₋₃, 20₄₋₆, . . . . Depending on the selection state of the selection circuit 10₁₋₆ as described above, as shown in FIG. 3, one amplifier 20₁₋₃ sequentially outputs the source signals of the first to third source lines (of a first sequence) in the first selection state (the preceding horizontal scanning period (H) in FIG. 3), and sequentially outputs the source signals of the fourth to sixth source lines (of a second sequence) in the second selection state (the following horizontal scanning period (H) in FIG. 3). On the other hand, the amplifier 20₄₋₆ sequentially outputs the source signals of the second sequence in the first selection state, and sequentially outputs the source signals of the first sequence in the second selection state.

Generally, the shift register, multiplexers, selection circuits, DACs and buffer amplifiers described above constitute signal supply means for supplying the multiplexed source signals. Incidentally, only a basic configuration is shown herein and various additions or changes are not eliminated and, for example, the DAC may further be equipped with voltage generation circuits corresponding to necessary grayscale levels.

These buffer amplifiers in the present example are formed in the outside of the panel 1 (back substrate 11) and, for example, are prepared as a peripheral attachment member of the panel 1 and are finally formed on a printed wiring electronic board incorporated into the panel 1. The electronic board has a structure for making electrical connection to the panel 1, and the multiplexed source signals from the buffer amplifiers 20₁₋₃, 20₄₋₆, . . . are supplied to a coupling part such as pads formed in the panel 1 in correspondence with the source signals. In the inside of the panel 1, a wiring pattern further extends from the coupling part and the pattern is connected to second selection circuits 30₁₋₆, . . . forming the first stage within the panel. In this manner, the multiplexed source signals from the buffer amplifiers 20₁₋₃, 20₄₋₆, . . . go over the panel boundary and are supplied to the second selection circuits 30₁₋₆, 30₇₋₁₂, . . . .

In a manner similar to the first selection circuits, the second selection circuits are also arranged to have the output terminals of the same number (two in the present example) as the number of inputs and select any one of the output terminals for each input and relay the input signals to the selected output terminals (see arrows of solid lines and dotted lines shown in the selection circuit 30₁₋₆ in FIG. 2). The multiplexed source signals outputted from the second selection circuits are supplied to the corresponding demultiplexers 40₁₋₃, 40₇₋₆, . . . , respectively.

The demultiplexers demultiplex the multiplexed source signals and generate respective source signals to be supplied to the corresponding source lines. For example, the demultiplexer 40₁₋₃ supplies the respective source signals to the source lines S1, S2 and S3 (see FIG. 3).

In the present embodiment, selection states of the first and second selection circuits are controlled in an interlock manner. The first and second selection circuits form signal paths for relaying the input signals as represented by arrows of solid lines shown in FIG. 2 in the first selection state, and form signal paths for relaying input signals as represented by arrows of dotted lines in the second selection state. Therefore, in the first selection state, an output signal of the DAC 9₁₋₃ is supplied to the demultiplexer 40₁₋₃ through the amplifier 20₁₋₃ and an output signal of the DAC 9₄₋₆ is supplied to the demultiplexer 40₄₋₆ through the amplifier 20₄₋₆. This is expressed in the preceding horizontal scanning period in FIG. 3, wherein the amplifier 20₁₋₃ outputs source signals for the first to third source lines and the source signals are delivered as outputs of the demultiplexer 40₁₋₃, while and the amplifier 20₄₋₆ outputs source signals for the fourth to sixth source lines and the source signals are delivered as outputs of the demultiplexer 40₄₋₆.

On the other hand, in the second selection state, an output signal of the DAC 9₁₋₃ is supplied to the demultiplexer 40₁₋₃ through the amplifier 20₄₋₆, and an output signal of the DAC 9₄₋₆ is supplied to the demultiplexer 40₄₋₆ through the amplifier 20₁₋₃. This is expressed in the following horizontal scanning period in FIG. 3, wherein the amplifier 20₁₋₃ outputs source signals for the fourth to sixth source lines and the source signals are delivered as outputs of the demultiplexer 40₄₋₆, while the amplifier 20₄₋₆ outputs source signals for the first to third source lines and the source signals are delivered as outputs of the demultiplexer 40₁₋₃.

Therefore, the amplifiers used for the signals inputted to the demultiplexers are alternately switched between the first selection state and the second selection state. As a result of this, even when the amplifier 20₁₋₃ and the amplifier 20₄₋₆ show different input-output characteristics, either of the inputs of the demultiplexers 40₁₋₃, 40₄₋₆ reflect the input-output characteristics of both the amplifiers for a period of 2H. Then, by repeating such alternating-switching of amplifiers, variations in the input-output characteristics are temporally diffused in each of the outputs of the amplifiers 20₁₋₃ and 20₄₋₆. As a result of this, the artifact of a stripe pattern appearing in a form along the source lines in a displayed image is mitigated.

The action and configuration of the source driver have been described concerning the first to sixth source lines, but similar action and configuration apply to other source lines. Therefore, image data is classified into source signals (for the source lines S1 to S3, S7 to S9, . . . ) of one sequence and source signals (for the source lines S4 to S6, S10 to S12, . . . ) of the other sequence following the one sequence, and the switching of signal paths as described above is performed with respect to the source signals of the adjacent one and the other sequences. As a result of this, mitigation in the artifact is achieved over the whole area of the displayed image.

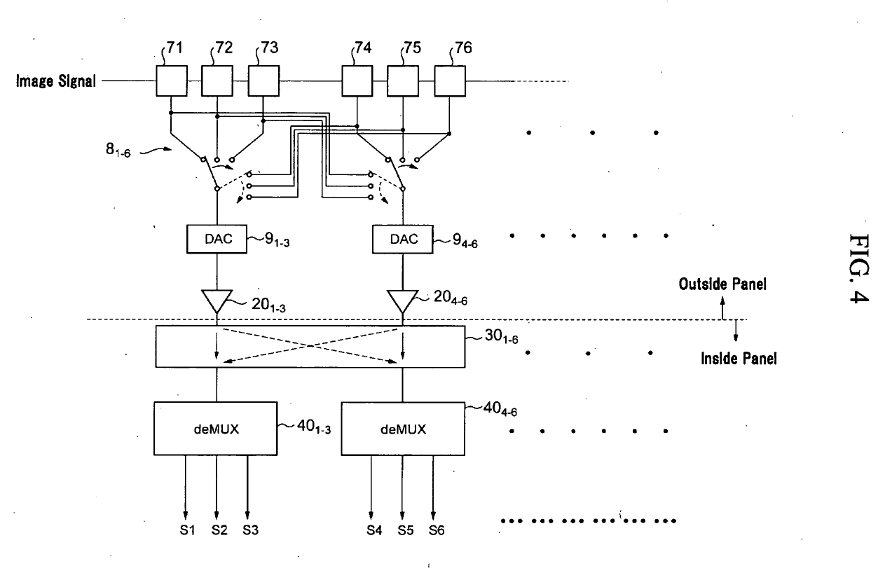

Although in FIG. 2 the first selection circuits are provided at the later stage of the DACs and form the signal paths in which the source signals of one sequence are always directed to the demultiplexers of the one sequence and the source signals of the other sequence are always directed to the demultiplexers of the other sequence, such configuration may be replaced by a configuration as shown in FIG. 4.

FIG. 4 is an alternative example of the embodiment shown in FIG. 2, wherein functions of the first selection circuits 10₁₋₆, 10₇₋₁₂, . . . are transferred to multiplexers 8₁₋₆, 8₇₋₁₂, . . . on the earlier stage of DACs. The illustrated multiplexer 8₁₋₆ multiplexes outputs of the one sequence of registers 71 to 73 and outputs the result in the first selection state to the DAC 9₁₋₃ (see solid lines), and multiplexes outputs of the other sequence of registers 74 to 76 and outputs to the DAC 9₁₋₃ in the second selection state (see dotted lines). On the other hand, to the DAC 9₄₋₆, outputs of the other sequence of registers 74 to 76 are multiplexed in the first selection state (see solid lines), and outputs of the one sequence of registers 71 to 73 are multiplexed in the second selection state (see dotted lines). Also in such a configuration, it is possible to form signal paths in which the source signals of the one sequence are always directed to the demultiplexer of the one sequence and the source signals of the other sequence are always directed to the demultiplexer of the other sequence.

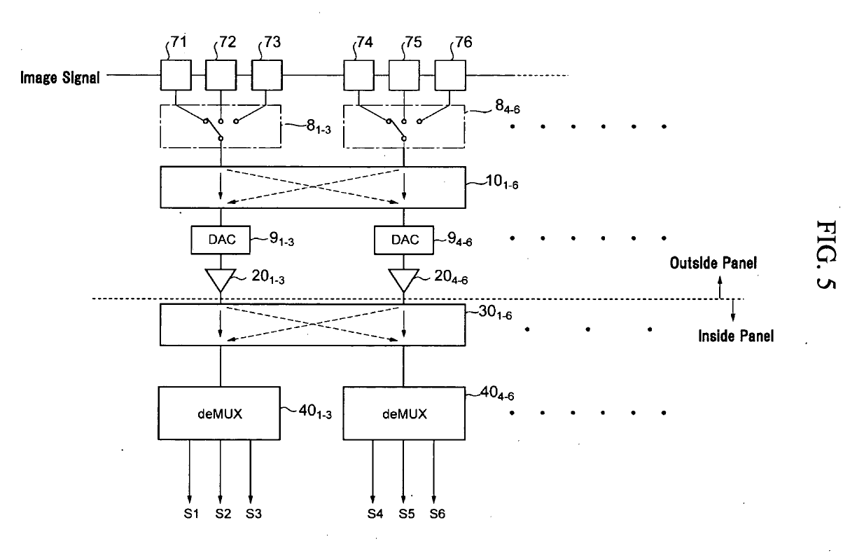

Incidentally, FIG. 5 shows a configuration equivalent to that shown in FIG. 4. This corresponds to a configuration in which the selection circuit 10₁₋₆ in FIG. 2 is simply replaced between the multiplexers 8₁₋₃, 8₄₋₆ and the DACs 9₁₋₃, DAC 9₄₋₆. That is, the selection circuit 10₁₋₆ in the signal supply means for supplying multiplexed source signals has outputs of the same number as the multiplexed source signals, and selects any one of the outputs for each of the multiplexed source signals to output one multiplexed source signal from the selected output. Then, this selection circuit 10₁₋₆ is interlocked with a selection state in a downstream selection circuit 30₁₋₆ to be subject to selection control so that a sequence of the multiplexed source signals inputted to the demultiplexers 40₁₋₃, 40₄₋₆ is kept constant even when the selection state is changed. Such a respect is functionally the same as in the configuration of FIG. 2 or 3.

It is noted that in the above description, switching of the signal paths has been performed every horizontal scanning period, but this is not limitation, and such switching may be performed at intervals of a predetermined plurality of horizontal scanning periods or at intervals of multiples of the horizontal scanning periods, or may be performed every field or frame of the image signal or every period of multiples of the field or frame. Also, the examples described above have been constructed so that the signal paths are always regularly exchanged between the first selection state and the second selection state in order for one amplifier 20₁₋₃ and the other amplifier 20₄₋₆ to be alternately used for a sequence of source lines. However, it is more desirable to randomly perform switching of the signal paths in order to prevent the occurrence of flicker of the stripe pattern.

Also, in the embodiment described above, the number of switchable signal paths (sequences) has been set at two, but it may naturally be set at three or more. As the number of switchable signal paths is larger, a spatial diffusion rate of variations in amplifiers becomes larger and visibility of an artifact of a stripe pattern can be reduced. The invention is also not limited to setting the number of source signals in a sequence at three. In other words, the number of source signals as multiplex objects can be two or more. In a manner similar to the above mention, even when the number of switchable signal paths is three or more, it is preferable to set the switching pattern random.

In addition, the case of disposing the amplifiers in the outside of the panel has been described, but the amplifiers may be formed in the inside of the panel. In the case of in-panel disposition, there is an advantage in that the number of amplifiers to be formed in the same substrate in which the TFTs etc. are formed can be decreased. Whether the decreasing the number of amplifiers to be formed is achieved in the inside or the outside of the panel, this decrease is worth much because the LTPS technique described above strongly requires less number of amplifiers. In the case of panel-outside disposition, there is a merit in that the number of connections between the panel and an externally attached electronic substrate can be kept small. Although the aforementioned case has been intended to form the signal supply means of the blocks 7, 8, 9, 10 and 20 in the outside of the panel, main part or all of these blocks may naturally be formed in the inside of the panel.

The above examples concern a transmission type display panel, but they can also be applied to display panels of a reflection type as well as the so-called transflective type.

The, the present invention is not necessarily limited to the active matrix type, and can basically be applied to a passive matrix type. Beside, the TFTs have been exemplified in the foregoing, but other driving elements may be used.

Further, in the above-described embodiments, the liquid crystal display panel has been used as a display panel, but it is not exclusive, and it is apparent that the present invention can also be applied to other type display panels such as EL (electroluminescence) displays.

The representative embodiments according to the invention have been described above, but the invention is not limited to these, and those skilled in the art can conceive various modifications within the appended claims.

### LIST OF REFERENCE NUMERALS

1: display panel
11: back substrate
12: tft
13: pixel electrode
S1,S2,S3: source line
G1,G2,G3: gate line
31: buffer memory
33: source driver
34: gate driver
51: timing controller
71,72,73: unit register
8₁₋₃,8₄₋₆: multiplexer
8₁₋₆: modified multiplexer
9₁₋₃,9₄₋₆: digital-to-analog converter
10₁₋₆: upstream selection circuit
20₁₋₃,20₄₋₆: buffer amplifier
30₁₋₆: downstream selection circuit
40₁₋₃,40₄₋₆: demultiplexer

1. A driving circuit for driving a plurality of column electrodes arranged in such a manner that the column electrodes cross a plurality of row electrodes, respectively, comprising:
signal supply means for outputting a plurality of multiplexed information signals in which column information signals to be applied to at least two column electrodes respectively are time-divisionally multiplexed;
selecting means having outputs of the same number as the multiplexed information signals for selecting any one of the outputs for each of the multiplexed information signals and outputting a multiplexed information signal from the selected output; and
demultiplex means for demultiplexing the multiplexed information signals outputted from the selecting means, respectively, and producing a column information signal to be applied to the corresponding column electrode,
the selecting means switching or setting a selecting state of the outputs for the multiplexed information signals at predetermined intervals.

2. A driving circuit as defined in claim 1, wherein the signal supply means output the multiplexed information signals via respective amplifiers.

3. A driving circuit as defined in claim 1, wherein the signal supply means comprise second selecting means having outputs of the same number as the multiplexed information signals for selecting any one of the outputs for each of the multiplexed information signals and outputting a multiplexed information signal from the selected output, the second selecting means being selection-controlled in conjunction with the selecting state to keep a series of multiplexed information signals to be inputted to the demultiplex means, to be the same, even if the selecting state is changed.

4. A driving circuit as defined in claim 1, wherein the column information signal is a pixel information signal, and the predetermined interval is a horizontal scanning period, frame or field period for a video signal formed by a group of the pixel information signals, or a multiple thereof.

5. A driving circuit as defined in claim 1, wherein the selecting state is set at random.

6. A driving circuit as defined in claim 1, wherein the row electrodes are selected according to a predetermined sequence or at a defined pattern, and the multiplexed information signals are updated each time selection-switching for the row electrodes are performed.

7. A display device using a driving circuit as defined in claim 1, wherein pixels are matrix-addressed by signals applied to the row and column electrodes.

8. A display device as defined in claim 7, comprising a display panel in which the signal supply means, the selecting means and the demultiplex means are formed.

9. A display device as defined in claim 7, comprising a display panel in which the selecting means and the demultiplex means are formed and an electronic board provided as a peripheral appendix member for the display panel, in which the signal supply means are formed.

10. A display device as defined in claim 8, comprising active elements or other drive elements for controlling a driving state for each pixel in accordance with signals applied to the row and column electrodes, the selecting means and demultiplex means being formed in a common process to a layer or material forming the drive elements.

11. A display device as defined in claim 10, wherein the display panel is a liquid crystal display panel, and the drive elements are thin film transistors formed in a low temperature polysilicon technology.

12. A display device as defined in claim 9, comprising active elements or other drive elements for controlling a driving state for each pixel in accordance with signals applied to the row and column electrodes, the selecting means and demultiplex means being formed in a common process to a layer or material forming the drive elements.

13. A display device as defined in claim 12, wherein the display panel is a liquid crystal display panel, and the drive elements are thin film transistors formed in a low temperature polysilicon technology.

14. A display device as defined in claim 1, wherein the selecting means directly output the multiplexed information signals to the outputs at a first selecting state and switches the multiplexed information signals to output the outputs at a second selecting state.

15. A display device as defined in claim 3, wherein the selecting means directly output the multiplexed information signals to the outputs at a first selecting state and switches the multiplexed information signals to output the outputs at a second selecting state, and the second selecting means directly output the multiplexed information signals to the outputs at the first selecting state and switches the multiplexed information signals to output the outputs at the second selecting state.
